(19) United States
(12) Patent Application Publication
(10) Pub. No.: US 2010/0127147 A1
(43) Pub. Date: May 27, 2010

(54) SUPPORTING MECHANISM OF SCANNING APPARATUS

(75) Inventor: Hsi-Tien Tang, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/359,972

(22) Filed: Jan. 26, 2009

(30) Foreign Application Priority Data
Nov. 21, 2008 (TW) 097145069

(51) Int. Cl. F16M 13/00

(52) U.S. Cl. 248/573

(57) ABSTRACT

A supporting mechanism of a scanning apparatus includes a cam rail, a stopping plate, a support frame and a spring. The scanning apparatus has a base and an upper cover. The support frame is arranged between the upper cover and the base. The support frame slides along the cam rail in a specified direction in order to open or close the upper cover. When the upper cover is opened, the support frame is used for supporting the upper cover.

### FIELD OF THE INVENTION

The present invention relates to a scanning apparatus, and more particularly to a supporting mechanism of a scanning apparatus.

### BACKGROUND OF THE INVENTION

With digitalized trend, scanning apparatuses such as image scanners, multifunction peripherals or printers are widely used for scanning images of documents. The scanned images can be converted into digital electronic files, which are then stored in a computer.

Conventionally, a scanning apparatus comprises a base and an upper cover. After the upper cover is uplifted, the user may place a document on the base of the scanning apparatus. As such, the image of the document may be scanned by a scanning module within the base and the scanned image of the document is then converted into a digital electronic file. After the scanning operation is completed, the upper cover should be uplifted again in order to withdraw the document. In other words, for facilitating introducing or withdrawing the document, the upper cover should be uplifted and then supported by the user's hand such that a space is retained between the upper cover and the base. As known, it is usually troublesome for the user to use his or her hand to support the upper cover during the procedure of introducing or withdrawing the document. For solving these drawbacks, a scanning apparatus with a supporting mechanism has been disclosed.

FIG. 1 is a schematic perspective view illustrating the supporting mechanism of a scanning apparatus according to the prior art. As shown in FIG. 1, the scanning apparatus 1 principally comprises a base 11, an upper cover 12 and a supporting mechanism 10. The supporting mechanism 10 is arranged between the base 11 and the upper cover 12. In a case that the upper cover 12 is uplifted, the upper cover 12 is supported by the supporting mechanism 10. Moreover, the supporting mechanism 10 includes a support frame 13 and a fixing part 14 (as shown in FIG. 2). An end of the support frame 13 is fixed on the upper cover 12. The other end of the support frame 13 is connected to the fixing part 14. The fixing part 14 is inserted into a recess of the base 11 and movably coupled with the base 11 such that the support frame 13 is fixed between the upper cover 12 and the base 11. Once the upper cover 12 is uplifted, a space is retained between the upper cover 12 and the base 11 for facilitating introducing or withdrawing a document to be scanned.

Although the supporting mechanism 10 is effective for supporting the upper cover 12, there are still some drawbacks. For example, whenever the upper cover 12 is opened (or uplifted) and closed, the support frame 13 and the fixing part 14 may collide with and rub against the base 11. After a long use period, some powdery crumbs are readily peeled off the supporting mechanism 10. If the powdery crumbs enter into the interior of the scanning apparatus 1, the scanning quality is deteriorated or even the scanning apparatus is damaged. In addition, the support frame 13 and the fixing part 14 are possibly deformed if the support frame 13 and the fixing part 14 rub against the base 11 for a long use period. When serious deformation occurs, the fixing part 14 fails to be fixed onto the base 11, and thus the fixing part 14 is detached from the base 11 (as shown in FIG. 2). Moreover, if the supporting mechanism 10 is damaged, the engaging part (not shown) of the base 11 to be engaged with the fixing part 14 should be replaced with a new one. Under this circumstance, both of the supporting mechanism 10 and the base 11 need to be replaced. The replacement of the supporting mechanism 10 and the base 11 may increase the cost of the scanning apparatus.

Therefore, there is a need of providing an improved supporting mechanism of a scanning apparatus so as to obviate the drawbacks encountered from the prior art.

### SUMMARY OF THE INVENTION

It is an object of the present invention to provide a supporting mechanism of a scanning apparatus so as to prevent damage of the base.

In accordance with an aspect of the present invention, there is provided a supporting mechanism of a scanning apparatus. The scanning apparatus includes a base and an upper cover. The upper cover is pivotally coupled to the base and foldable with respect to the base. The supporting mechanism includes a cam rail, a stopping plate, a support frame and a spring. The cam rail is disposed on the base. The cam rail has an open position and a close position. The stopping plate is disposed within the cam rail. The support frame includes a protrusion, which is formed on a first end thereof and accommodated in the cam rail. A second end of the support frame is connected to the upper cover. The spring is connected to the second end of the support frame and sustained against the upper cover to exert an elastic force on the support frame. When the protrusion is located at the close position and the upper cover is uplifted, the protrusion is stopped by the stopping plate and slides from the close position to the open position in a first direction. When the protrusion is located at the open position and the upper cover is continuously uplifted, the protrusion continuously slides in the first direction through the stopping plate to the close position.

In an embodiment, the stopping plate includes a slant and a stopper. The slant ascends in the first direction for allowing the protrusion to slide thereon in the first direction. The stopper is used for stopping the protrusion such that the protrusion is permitted to slide in the first direction.

In an embodiment, a first included angle is formed between the upper cover and the base when the protrusion is located in the open position.

In an embodiment, a second included angle is formed between the upper cover and the base during the protrusion slides from the open position to the close position, wherein the second included angle is larger than the first included angle.

In an embodiment, the support frame further includes a first fixing post and a second fixing post. The first fixing post and a second fixing post are formed on a second end of the support frame and partially embedded into the upper cover for connecting the support frame and the upper cover.

In an embodiment, the spring is arranged between the first fixing post and the second fixing pos. The spring has a first spring pin sustained against the support frame and a second spring pin sustained against the upper cover so as to exert the elastic force on the support frame.

Preferably, the scanning apparatus is an image scanner, a multifunction peripheral or a printer.

In an embodiment, the first direction is an anti-clockwise direction.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the supporting mechanism of a scanning apparatus according to the prior art;

FIG. 2 schematically illustrates the detachment of the supporting mechanism from the base of the scanning apparatus shown in FIG. 1;

FIG. 3 is a schematic view illustrating a supporting mechanism of a scanning apparatus in a close status according to a first preferred embodiment of the present invention;

FIG. 4 is a schematic partially exploded view illustrating the supporting mechanism of the scanning apparatus according to the present invention;

FIG. 5 is a schematic perspective view illustrating the supporting mechanism of the scanning apparatus in the close status according to the present invention;

FIG. 6 is a schematic partial perspective view illustrating the cam rail and the stopping plate of the scanning apparatus according to the present invention;

FIG. 7 is a schematic side view illustrating the supporting mechanism of the scanning apparatus in an open status according to the present invention; and

FIG. 8 is a schematic side view illustrating the supporting mechanism of FIG. 7 during the process of switching from the open status to the close status.

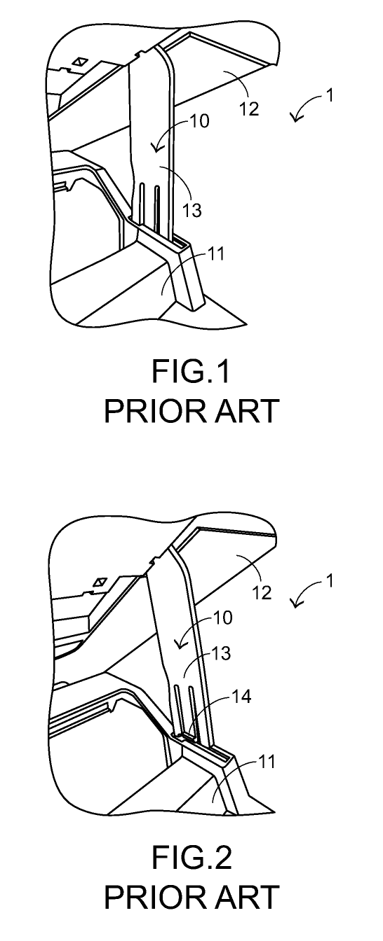

### DETAILED DESCRIPTION OF THE PREFERRED EMBODIMENT

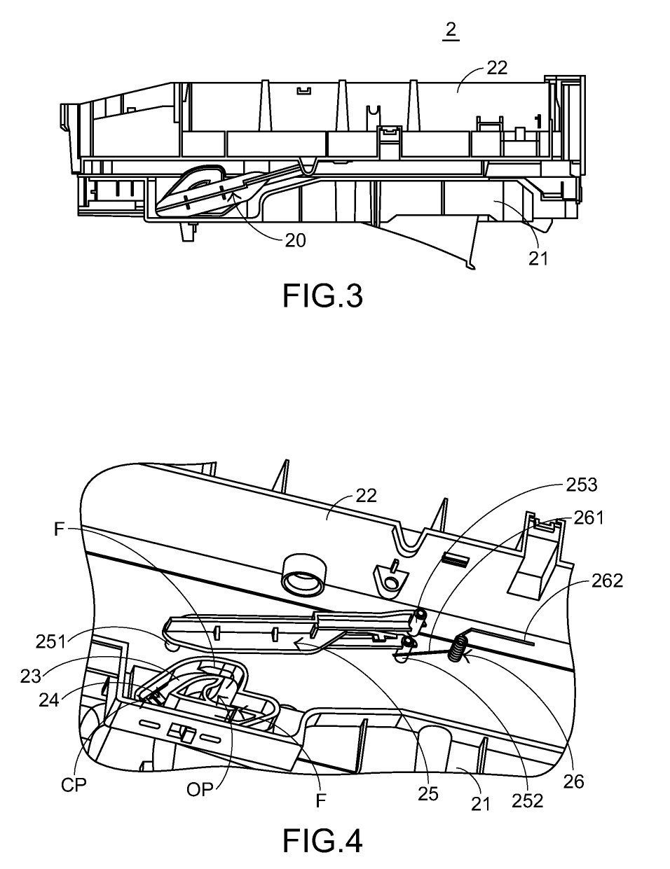

FIG. 3 is a schematic view illustrating a supporting mechanism of a scanning apparatus in a close status according to a preferred embodiment of the present invention. The scanning apparatus 2 principally comprises a base 21 and an upper cover 22. The upper cover 22 is pivotally coupled to the base 21 and foldable with respect to the base 21. As shown in FIG. 3, the upper cover 22 is laid on the base 21 and the scanning apparatus 2 is in a close status.

FIG. 4 is a schematic partially exploded view illustrating the supporting mechanism of the scanning apparatus according to the present invention. As shown in FIG. 4, the supporting mechanism 20 of the scanning apparatus 2 comprises a cam rail 23, a stopping plate 24, a support frame 25 and a spring 26. The cam rail 23 is disposed on the base 21. The cam rail 23 has an open position OP and a close position CP. The stopping plate 24 is disposed within the cam rail 23. The stopping plate 24 has a slant 241 and a stopper 242 (as shown in FIG. 6). A protrusion 251 is formed on a first end of the support frame 25. A first fixing post 252 and a second fixing post 253 are formed on a second end of the support frame 25. The spring 26 is connected to the second end of the support frame 25 and sustained against the upper cover 22 to exert an elastic force on the support frame 25. The spring 26 has a first spring pin 261 and a second spring pin 262.

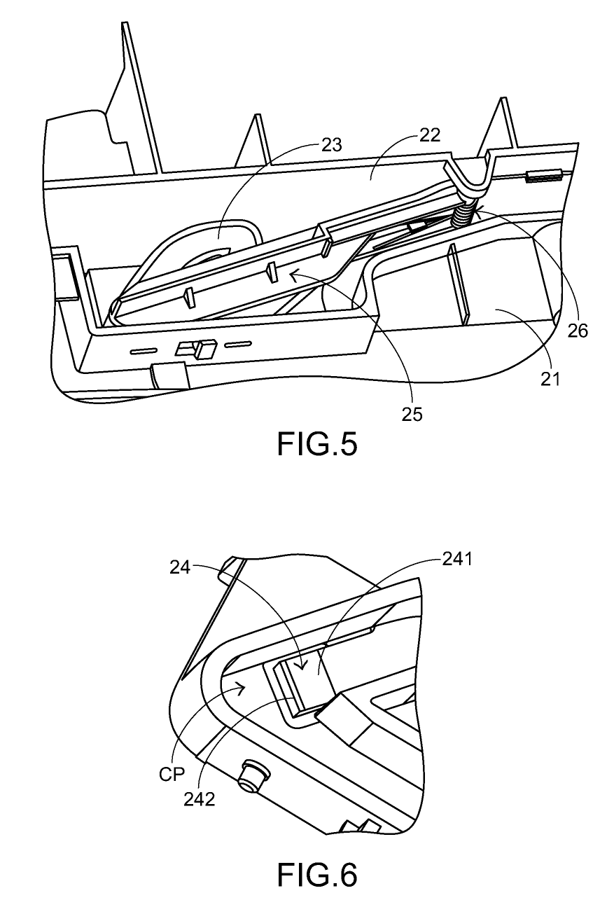

FIG. 5 is a schematic perspective view illustrating the supporting mechanism of the scanning apparatus in the close status according to the present invention. Please refer to FIG. 4 and FIG. 5. The protrusion 251 on the first end of the support frame 25 is accommodated in the cam rail 23. The first fixing post 252 and the second fixing post 253 on the second end of the support frame 25 are coupled to the upper cover 22, so that the support frame 25 is fixed onto the upper cover 22. The spring 26 is arranged between the first fixing post 252 and the second fixing post 253. The first spring pin 261 is sustained against the support frame 25 and the second spring pin 262 is sustained against the upper cover 22, so that the spring 26 exerts an elastic force on the support frame 25. Due to the elastic force, the support frame 25 is movable in the cam rail 23. In a case that the scanning apparatus 2 is in the close status, the protrusion 251 is located at the close position CP. When an upward force is exerted on the upper cover 22 to uplift the upper cover 22, the protrusion 251 is stopped by the stopping plate 24 and thus slides from the close position CP in a first direction F. In this embodiment, the first direction F is an anti-clockwise direction. FIG. 6 is a schematic partial perspective view illustrating the cam rail and the stopping plate of the scanning apparatus according to the present invention. As shown in FIG. 6, the stopping plate 24 is disposed above the close position CP. By the stopper 242 of the stopping plate 24, the protrusion 251 is hindered from being moved in the clockwise direction.

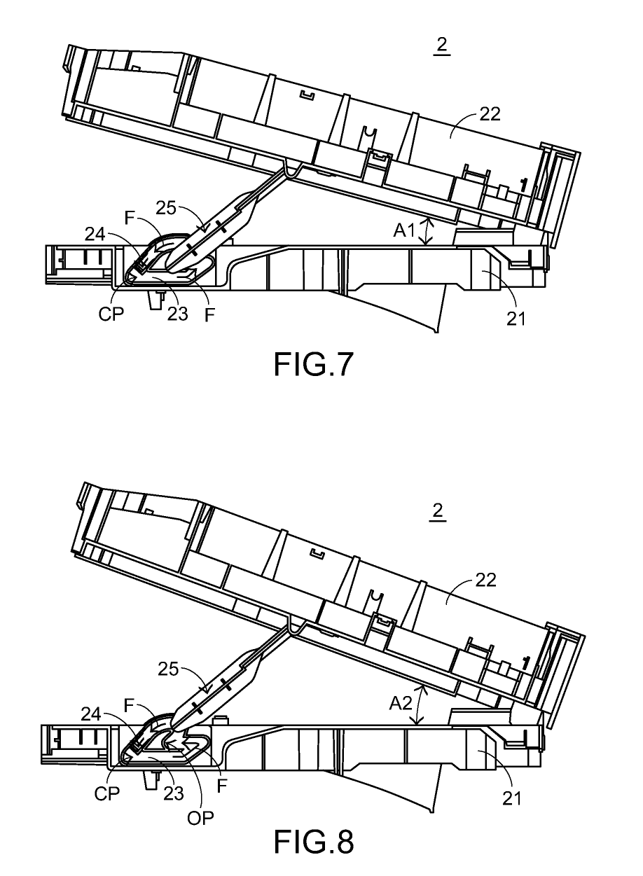

Since the protrusion 251 is stopped by the stopping plate 24, the elastic force offered by the spring 26 will cause the upward force to slide the protrusion 251 along the cam rail 23 in the first direction F. As the protrusion 251 slides, the support frame 25 and the upper covered are moved. Until the protrusion 251 is slides from the close position CP to the open position OP along the cam rail 23, the upper cover 22 is uplifted and the supported by the support frame 25. As a consequence, the upper cover 22 is retained in the open status and a first included angle A1 is formed between the upper cover 22 and the base 21 (as shown in FIG. 7). In this embodiment, a concave structure is formed in the sidewall of the cam rail 23 adjacent to the open position OP. When the protrusion 251 slides to the open position OP, the protrusion 251 is partially received the concave structure adjacent to the open position OP. Under this circumstance, the protrusion 251 stops sliding and the protrusion 251 is positioned at the open position OP.

On the other hand, for closing the upper cover, the user may slightly raise the upper cover 22. The elastic force generated by the spring 26 will cause the protrusion 251 continuously slides from the open position OP in the first direction F (anti-clockwise direction). When the protrusion 251 is moved to the uppermost position of the cam rail 23, a second included angle A2 is formed between the upper cover 22 and the base 21 (as shown in FIG. 8), wherein the second included angle A2 is larger than the first included angle A1.

The protrusion 251 continuously slides from the uppermost position in the first direction F to the stopping plate 24. Since the slant 241 of the stopping plate 24 ascends in the first direction F, the protrusion 251 will continuously glide on the slant 241 while compressing the slant 241. Afterwards, the protrusion 251 passes through the slant 241 to the close position CP and the scanning apparatus is in the close status again (as shown in FIG. 3). At this moment, the protrusion 251 is hindered by the stopper 242 of the stopping plate 24 from being moved in the clockwise direction.

In the above embodiments, the supporting mechanism 20 of the scanning apparatus 2 of the present invention utilizes a cam rail 23 to guide the support frame 25. In addition, by means of the stopping plate 24 and the spring 26, the protrusion 251 of the support frame 25 is permitted to slide in the first direction F (anti-clockwise direction). By slightly uplifting the upper cover 22, the operating mode of the support frame 25 is switched. That is, the supporting mechanism 20 is operated without difficulty. Since the cam rail 23 is mounted on the base 21, the support frame 25 will no longer collide with or rub against the base 21 even if the upper cover 22 is frequently opened or closed. In other words, only the support frame 25 and the cam rail 23 are possibly damaged from abrasion between the support frame 25 and the cam rail 23. Since the cam rail 23 is an independent component mounted on the base 21, the base 21 can be well maintained. Under this circumstance, only the support frame 25 and the cam rail 23 need to be replaced, but the base 21 needs not be replaced with a new one.

From the above description, the supporting mechanism of the scanning apparatus of the present invention has a simplified structure and easily operated. In addition, the process of replacing the support frame or the cam rail is very simple. Since the base needs not be replaced with a new one, the scanning apparatus of the present invention is more cost-effective.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A supporting mechanism of a scanning apparatus, said scanning apparatus comprising a base and an upper cover, said upper cover being pivotally coupled to said base and foldable with respect to said base, said supporting mechanism comprising:
a cam rail disposed on said base, and having an open position and a close position;
a stopping plate disposed within said cam rail;
a support frame comprising a protrusion, which is formed on a first end thereof and accommodated in said cam rail, wherein a second end of said support frame is connected to said upper cover; and
a spring connected to said second end of said support frame and sustained against said upper cover to exert an elastic force on said support frame, wherein when said protrusion is located at said close position and said upper cover is uplifted, said protrusion is stopped by said stopping plate and slides from said close position to said open position in a first direction, and when said protrusion is located at said open position and said upper cover is continuously uplifted, said protrusion continuously slides in said first direction through said stopping plate to said close position.

2. The supporting mechanism according to claim 1 wherein said stopping plate comprises:
a slant ascending in said first direction for allowing said protrusion to slide thereon in said first direction; and
a stopper for stopping said protrusion such that said protrusion is permitted to slide in said first direction.

3. The supporting mechanism according to claim 1 wherein a first included angle is formed between said upper cover and said base when said protrusion is located in said open position.

4. The supporting mechanism according to claim 3 wherein a second included angle is formed between said upper cover and said base during said protrusion slides from said open position to said close position, wherein said second included angle is larger than said first included angle.

5. The supporting mechanism according to claim 1 wherein said support frame further comprises a first fixing post and a second fixing post, which are formed on a second end of said support frame and partially embedded into said upper cover, for connecting said support frame and said upper cover.

6. The supporting mechanism according to claim 5 wherein said spring is arranged between said first fixing post and said second fixing post, and said spring has a first spring pin sustained against said support frame and a second spring pin sustained against said upper cover so as to exert said elastic force on said support frame.

7. The supporting mechanism according to claim 1 wherein said scanning apparatus is an image scanner, a multifunction peripheral or a printer.

8. The supporting mechanism according to claim 1 wherein said first direction is an anti-clockwise direction.
